(19) United States
(12) Patent Application Publication
(10) Pub. No.: US 2009/0279215 A1
(43) Pub. Date: Nov. 12, 2009

(54) Protecting device for multi-motors and method thereof

(76) Inventors: Chih-Ming Chang, Taipei City (TW); Ju-Chou Chen, Banciao City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/216,657

(22) Filed: Jul. 9, 2008

(30) Foreign Application Priority Data
May 7, 2008 (TW) 97116753

(51) Int. Cl. H02H 7/08

(52) U.S. Cl. 361/31; 340/648

(57) ABSTRACT

A protecting device for multi-motors driven by motor driving circuits for operating motors includes a comparison module, an operative logic module and a control module. The comparison module determines whether or not an abnormal over current occurs in the motors. The operative logic module receives a determination result of the comparison module and outputting a motor control signal to the motor driving circuit and a notice signal to the control module. If an over current occurs in the motor, the motor control signal outputted from the operative logic module will be a disable signal for stopping the operation of the motor driving circuit and the motor. The control module outputs a warning signal based on the notice signal to notify users about the operating status of the motor. Therefore, the present invention can prevent the motor driving circuit and the motor from being damaged by an over current.

### BACKGROUND OF THE INVENTION

1. Field of the Invention

The present invention relates to a protecting device, and more particularly to a protecting device for multi-motors and a method for protecting the motors.

2. Description of Related Art

Regarding office machinery, multifunctional operations are provided to satisfy the requirements of users in the office, but the office machinery should not only emphasize on the convenience of operation, but also satisfy stable functional operations. For example, the frequency of the failure of office machinery will affect the users' work performance.

With reference to FIG. 1 for a functional block diagram of a traditional office machine, a control module 90 of the office machine 9 is provided for controlling a scanning module 95, a facsimile module 97, and a printing module 99 to perform a scanning, faxing or printing job respectively. When the control module 90 controls the scanning module 95, the facsimile module 97 and the printing module 99, a motor module 91 is driven to control a paper feeding module 93 to supply paper for the jobs required by the scanning module 95, the facsimile module 97 and the printing module 99. The motor module 91 comprises a plurality of motor driving circuits and a plurality of motors (not shown in the figure), and the motor module 91 mainly provides a moving force for the operation of the paper feeding module 93 to supply paper.

However, paper jam is one of the common failures that occurs in an office machine 9. If paper is jammed in the office machine 9, the motor driving circuit will output a signal to notify the control module 90, so that the control module 90 can inform users about the paper jam condition through a display, and allows users to fix the paper jam problem accordingly. However, the procedure of eliminating the paper jam in the office machine 9 is a passive protecting mechanism that requires user intervention in order to remove the paper and fix the paper jam problem. Before the user removes the jammed paper, the motor driving circuit and the motor will carry an over current, which may burn or damage these components.

Furthermore, the motors in the motor module 91 may operate to perform the scanning, faxing and printing jobs simultaneously. When many motors are operating at the same time, the motor driving circuit and the motor also bear an over-current risk that may burn or damage the motor driving circuit and the motor. Therefore, finding a way or developing a device to protect the motor components demands immediate attentions and feasible solutions.

### SUMMARY OF THE INVENTION

In view of the foregoing shortcomings of the prior art, the present invention provides a protecting device for multi-motors and a method of protecting the motors in accordance with the present invention to overcome the over-current issue occurred during the operation of the motors and prevent the motors from being burned out or damaged.

Therefore, it is a primary objective of the present invention to provide a protecting device capable of controlling and stopping the operation of the motors actively when an over current occurs, so as to prevent the motor and the motor driving circuit from being burned out and damaged.

To achieve the foregoing objective, the present invention provides a protecting device for multi-motors, and the motors are driven by a plurality of motor driving circuits, and the protecting device comprises: a comparison module, an operative logic module and a control module. The comparison module is provided for comparing a working voltage of each motor against a predetermined voltage and outputting a compare signal according to a comparison result. If the comparison result shows that the working voltage is greater than the predetermined voltage, then the outputted compare signal will be an abnormal signal. If the working voltage is smaller than the predetermined voltage, then the outputted compare signal will be a normal signal. The operative logic module receives the compare signal and determines whether or not an abnormal signal shows up in the compare signals, and outputs at least one notice signal and at least one motor control signal outputted to the motor driving circuits according to the determination result. The control module is provided for receiving a notice signal, and a warning signal is outputted according to the notice signal.

In a preferred embodiment of the present invention, if the abnormal signal occurs in at least one of the compare signals, the operative logic module will output a notice signal to the control module and a motor control signal to at least one of the motor driving circuits, and the motor control signal is a disable signal for controlling and stopping the operation of the motor driving circuit.

A preferred embodiment of the present invention further comprises a display module controlled by a control module for displaying an error status of the motors according to a received warning signal.

To overcome the foregoing technical issue, the present invention further provides a method of protecting multi-motors, and the motors are driven by a plurality of motor driving circuits, and the method comprises the steps of: comparing a working voltage of each motor with a predetermined voltage; outputting a compare signal according to a comparison result, such that if the comparison result shows that the working voltage is greater than the predetermined voltage, the outputted compare signal will be an abnormal signal, and if the working voltage is smaller than the predetermined voltage, then the outputted compare signal will be a normal signal; determining whether or not the abnormal signal shows up in the compare signals, and outputting at least one notice signal and at least one motor control signal outputted to the motor driving circuit according to the determination result; and outputting a warning signal to remind users about the failure of the motor according to the notice signal.

With the foregoing preferred embodiments, the present invention determines whether or not an over current occurs in a motor by a voltage comparison, such that if an over current occurs in a motor, a motor control signal will be outputted to control and stop the operation of the motor driving circuit to achieve the effect of protecting the motor and the motor driving circuit from being burned out or damaged by the over current. Furthermore, the present invention outputs a warning signal to remind users about the over current occurred in the motor, and allows users to eliminate the over current.

In addition to the general description above, preferred embodiments together with related drawings are provided for illustrating the method, technical measure and performance of the present invention that achieve the expected objectives, and other objectives and advantages of the present invention will be described as follows.

### BRIEF DESCRIPTION OF THE DRAWINGS

FIG. 1 is a functional block diagram of a conventional office machine;

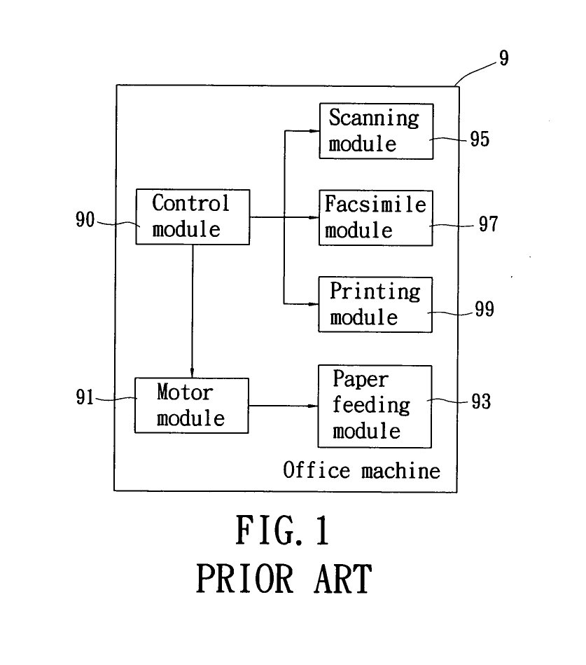

FIG. 2 is a functional block diagram of a protecting device for multi-motors in accordance with a preferred embodiment of the present invention;

FIG. 3 is a schematic view of a circuit used for the protecting device of FIG. 2;

FIG. 4 is another schematic view of a circuit used for the protecting device of FIG. 2; and

FIG. 5 is a flow chart of a method of protecting multi-motors in accordance with a preferred embodiment of the present invention.

### DETAILED DESCRIPTION OF THE PREFERRED EMBODIMENTS

The present invention provides a protecting device for multi-motors and a method of protecting the motors, and the protecting device provides an over-current protection for a machine or an equipment while a plurality of motors are operating simultaneously. The present invention detects any abnormal operation of a motor caused by an over current of the motor and allows users to take preventive actions to protect the motor or related circuits from being burned out or damaged by the over current. If an abnormal situation occurs in the motor, the present invention can show the failure condition of the motor, in addition to an immediate termination of the operation of the motor and its related circuits.

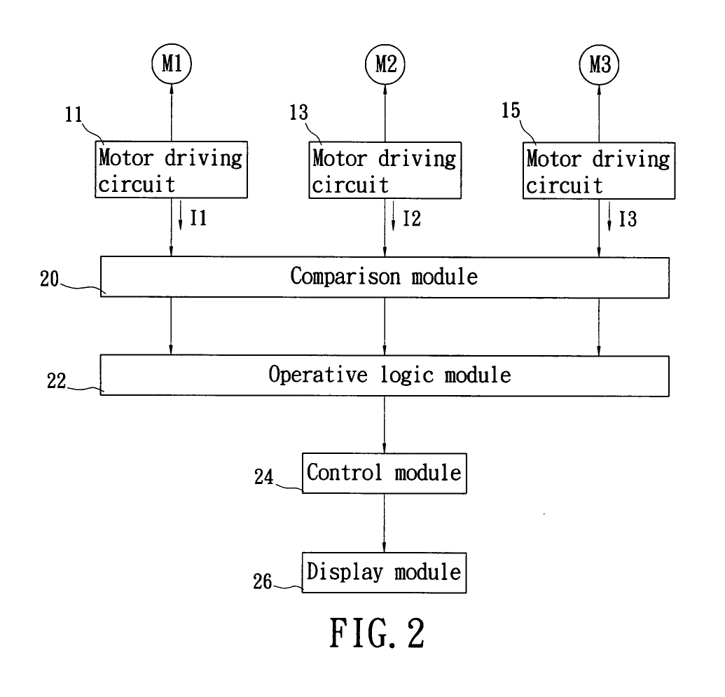

With reference to FIG. 2 for a functional block diagram of a protecting device for multi-motors in accordance with a preferred embodiment of the present invention, the protecting device is applied to an office machine such as a multifunctional printer (MFP). In FIG. 2, a plurality of motors M1, M2, M3 in the office machine are transmission motors provided for supplying paper through different paths, and these motors M1, M2, M3 are controlled by a plurality of motor driving circuits 11, 13, 15 respectively, and the motor driving circuits 11, 13, 15 are provided for controlling, starting or stopping the operations of the motors M1, M2, M3.

In FIG. 2, the protecting device comprises a comparison module 20, an operative logic module 22, a control module 24 and a display module 26. The comparison module 20 is provided for determining whether or not an over current occurs in the working current of each motor M1, M2, M3. In the actual operation of the comparison module 20, a working current I1, I2, I3 of a motor driving circuit 11, 13, 15 of each motor M1, M2, M3 is measured and converted into a working voltage of each motor M1, M2, M3 respectively. The comparison module 20 compares the working voltage against a predetermined voltage, and each predetermined voltage can be set to a different value based on the operating characteristics of different motors M1, M2, M3 for the comparison.

The comparison module 20 outputs a compare signal according to a comparison result of the working voltage of each motor M1, M2, M3. For example, if the working voltage of the motor M1 is smaller than the predetermined voltage, then the outputted compare signal will be considered as a normal signal; on the other hand, if the working voltage of the motor M1 is greater than the predetermined voltage, then the outputted compare signal will be considered as an abnormal signal. An over current may occur in the motor M1. For instance, paper jam may occur in an office machine, or an over current caused by operating several motors simultaneously may occur in the office machine.

The operative logic module 22 is coupled to the comparison module 20 for receiving a comparison result of the comparison module 20, and outputting a corresponding motor control signal to the motor driving circuit 11, 13, 15, according to the comparison result, and the motor control signal is an enable signal for controlling a normal operation of the motor driving circuit 11, 13, 15, or a disable signal for terminating the operation of the motor driving circuit 11, 13, 15. In this preferred embodiment, if the operative logic module 22 has an over current occurred in at least one of the motors M1, M2, M3 and one of the compare signals outputted by the comparison module 20 is an abnormal signal, then the operative logic module 22 will output the disable signal to terminate all jobs of the motor driving circuits 11, 13, 15 to protect the motors M1, M2, M3 and motor driving circuits 11, 13, 15 from being burned out or damaged by the over current. In addition, the operative logic module 22 also outputs a notice signal to a control module 24 according to the comparison result of the comparison module 20 to specify which one of the motors has an over-current problem.

The control module 24 is coupled to the operative logic module 22 for receiving the notice signal outputted from the operative logic module 22, and outputs a warning signal to a display module 26 according to the output of the notice signal, such that the display module 26 can notify users about which motor having an error in the office machine, so that users can troubleshoot and fix the related problem accordingly.

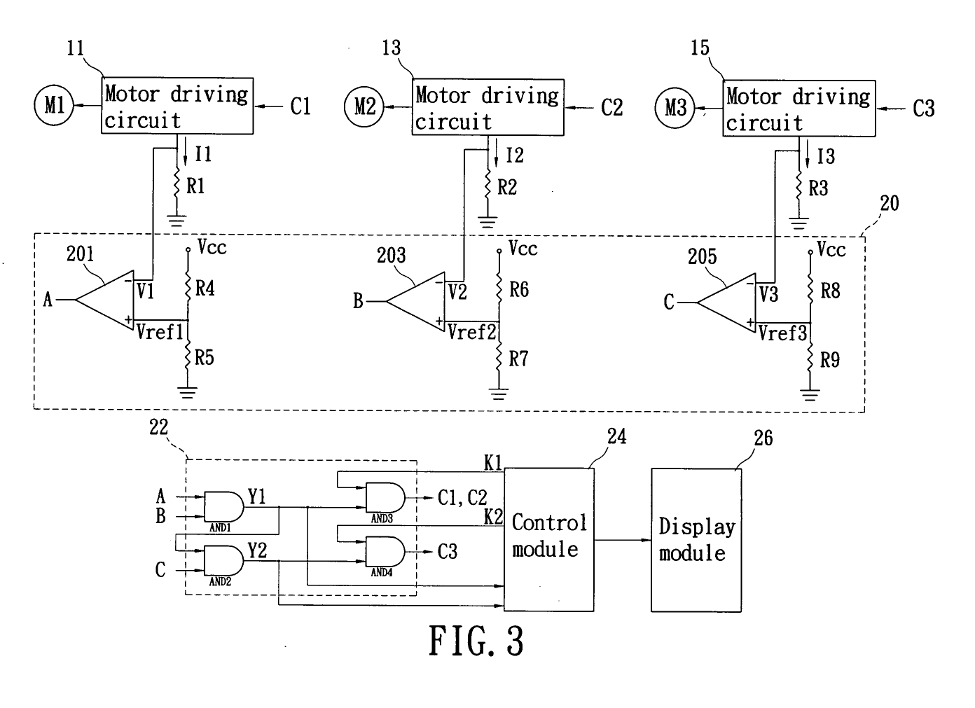

With reference to FIG. 3 for a schematic view of a circuit for implementing the protecting device as depicted in FIG. 2, the comparison module 20 comprises a plurality of compare circuits 201, 203, 205, wherein the negative input terminal of the compare circuit 201 is connected to an output terminal of the motor driving circuit 11, and the positive input terminal of the compare circuit 201 is connected to a predetermined voltage Vref1. A current I1 of the output terminal of the motor driving circuit 11 is the working current of the motor M1, and the current I1 produces a working voltage V1 of the motor M1 at a resistor R1. Therefore, when the compare circuit 201 is operating, the working voltage V1 and the predetermined voltage Vref1 are compared. If the working voltage V1 is smaller than the predetermined voltage Vref1, a compare signal A outputted from the compare circuit 201 has a high potential, and the compare signal A is a normal signal. If the working voltage V1 is greater than a predetermined voltage Vref2, the compare signal A outputted from the compare circuit 201 has a low potential, and the compare signal A is an abnormal signal; in other words, the working current of motor M1 is too high.

The operating principle of the compare circuit 203, 205 is the same as that of the compare circuit 201, and thus will not be described here. The predetermined voltages Vref1, Vref2, Vref3 can be set to different values based on the operating characteristics of each motor M1, M2, M3.

In FIG. 3, the operative logic module 22 is comprised of a plurality of AND gate circuits AND1˜AND4, wherein an input terminal of the AND gate circuit AND1 receives a compare signal A, B and outputs a signal Y1; an input terminal of the AND gate circuit AND3 receives a signal Y1, K1 and outputs a signal C1, C2; an input terminal of the AND gate circuit AND2 receives a compare signal C and a signal Y1 and outputs a signal Y2; an input terminal of the AND gate circuit AND4 receives a signal Y2, K2 and outputs a signal C3. The signals Y1, Y2 are notice signals outputted from the operative logic module 22, and the signals K1, K2 are high potential signals provided by the control module 24, and the signals C1˜C3 are motor control signals inputted to the motor driving circuits 11, 13, 15. In FIG. 3, if the motor driving circuits 11, 13, 15 are enabled, the motor control signals will have a high potential, and if the motor driving circuits 11, 13, 15 are disabled, the motor control signals will have a low potential.

The AND gate circuits AND1, AND2 detect whether or not an abnormal signal shows up in the compare signals A, B, C, and the AND gate circuits AND3, AND4 output the motor control signals C1˜C3 according to a computing result of the AND gate circuits AND1, AND2. For instance, if the compare signal is a normal signal or the signals A, B, C have a high potential, then signals Y1, Y2 outputted by the AND gate circuits AND1, AND2 will have a high potential. After the signals Y1, Y2 are computed by the AND gate circuits AND3, AND4, the signals C1, C2, C3 outputted from the AND gate circuits AND3, AND4 will be high potential signals, and thus the motor control signals received by the motor driving circuits 11, 13, 15 are enable signals having a high potential, and the motors M1, M2, M3 can be operated normally. On the other hand, if one of the compare signals A, B is an abnormal signal (or one of the signals A, B has a low potential), then the signals Y1, Y2 outputted by the AND gate circuits AND1, AND2 have a low potential. After the signals Y1, Y2 are computed by the AND gate circuits AND3, AND4, the signals C1, C2, C3 outputted by the AND gate circuits AND3, AND4 are low potential signals, such that the motor control signals received by the motor driving circuits 11, 13, 15 are disable signals having a low potential, and the operation of the motors M1, M2, M3 will be terminated.

If only the compare signal C is an abnormal signal (or the signal C has a low potential), then the signal Y1 outputted by the AND gate circuit AND1 has a high potential, and the signal Y2 outputted by the AND gate circuit AND2 has a low potential. After the signals Y1, Y2 are computed by the AND gate circuits AND3, AND4, the signals C1, C2 outputted by the AND gate circuit AND3 are high potential signals, and the signal C3 outputted by the AND gate circuit AND4 is a low potential signal, such that if the motor control signal received by the motor driving circuit 11, 13 is an enable signal having a high potential, the motors M1, M2 will be operated normally. If the motor control signal received by the motor driving circuit 15 is a disable signal having a low potential, the operation of the motor M3 will be terminated.

The signals Y1, Y2 are also outputted to the control module 24, so that the control module 24 knows about the position of the failed motor based on the content of the signals Y1, Y2. For example, if the signal Y1 has a low potential, then at least one of the motors M1, M2 has failed, and if Y1 has a high potential and Y2 has a low potential, then the motor M3 is failed. In the meantime, the control module 24 outputs a warning signal to the display module 26 after the information of the failed motor is known. The display module 26 displays the information of the failed motor to remind users based on the warning signal.

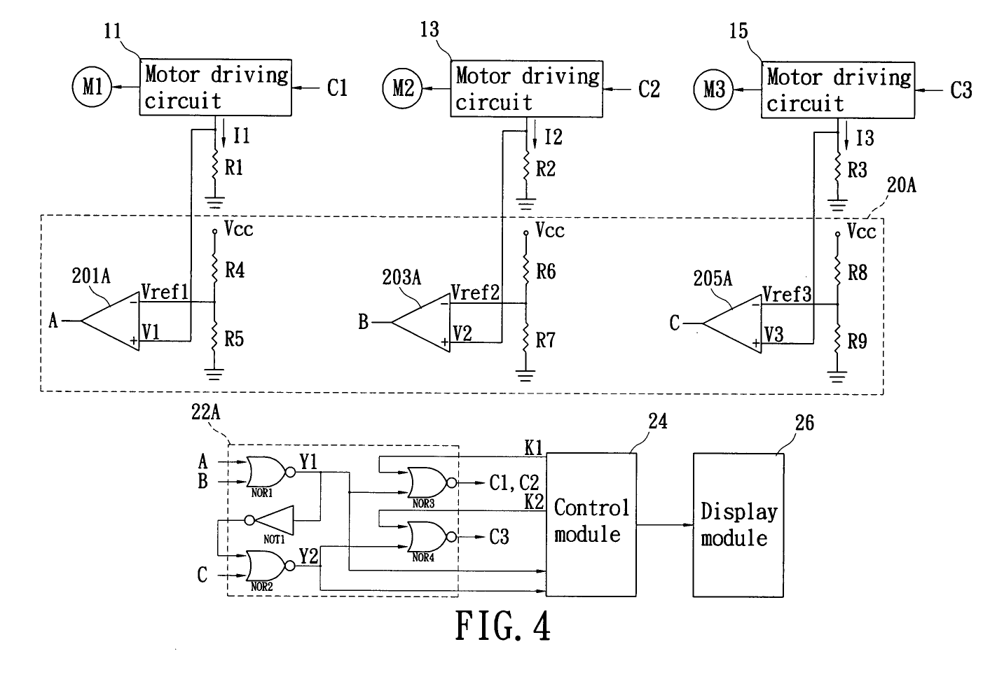

With reference to FIG. 4 for another schematic view of a circuit used for the protecting device of FIG. 2, the difference between FIG. 4 and FIG. 3 resides on that the circuits implemented in the comparison module 20A and the operative logic module 22A are slightly different. The comparison module 20A as shown in FIG. 4 comprises a plurality of compare circuits 201A, 203A, 205A, and the negative input terminal of the compare circuit 201A is connected to a predetermined voltage Vref1 and the positive input terminal of the compare circuit 201A is connected to an output terminal of a motor driving circuit 11. When the compare circuit 201A is operating, the working voltage V1 is compared with the predetermined voltage Vref1. If the working voltage V1 is smaller than the predetermined voltage Vref1, the compare signal A outputted from the compare circuit 201A will have a low potential, and the compare signal A will be a normal signal. If the working voltage V1 is greater than the predetermined voltage Vref2, the compare signal A outputted from the compare circuit 201A will have a high potential, and the compare signal A will be an abnormal signal; in other words, the working current of the motor M1 is too high.

The operating principle and the compare circuit 201A of the compare circuits 203A, 205A are the same, and thus will not be described here again.

The operative logic module 22A as shown in FIG. 4 is implemented by the NOR gate circuits NOR1˜NOR4 instead of using the AND gate circuit AND in the operative logic module 22 as shown in FIG. 3, and the signal Y1 outputted by the NOR gate circuit NOR1 is processed by a NOT circuit (a.k.a. inverter) NOT1 and outputted to an input terminal of the NOR gate circuit NOR2. The signals Y1, Y2 in FIG. 4 are notice signals outputted by the operative logic module 22A, and the signals K1, K2 are low potential signals provided by the control module 24, and the signals C1˜C3 are motor control signals inputted to the motor driving circuits 11, 13, 15. If the motor driving circuit in FIG. 4 is enabled, the motor control signal will have a low potential and if the motor driving circuit is disabled, the motor control signal will have a high potential.

In the operation of the operative logic module 22A, if the compare signal is a normal signal and the compare signals A, B, C have a low potential, then the signals Y1, Y2 outputted by the NOR gate circuits NOR1, NOR2 have a high potential. After the signals Y1, Y2 are computed by the NOR gate circuits NOR3, NOR4, the signals C1, C2, C3 outputted by the NOR gate circuits NOR3, NOR4 are low potential signals, and thus the motor control signals received by the motor driving circuit 11, 13, 15 are enable signals having a low potential, and the motors M1, M2, M3 can be operated normally. On the other hand, if one of the compare signals A, B is an abnormal signal and the compare signal C is a normal signal (or one of the signals A, B has a high potential), then the signals Y1, Y2 outputted by the NOR gate circuits NOR1, NOR2 have a low potential. After the signals Y1, Y2 are computed by the NOR gate circuits NOR3, NOR4, the signals C1, C2, C3 outputted by the NOR gate circuits NOR3, NOR4 are high potential signals, and thus the motor control signals received by the motor driving circuits 11, 13, are disable signals having a high potential, and the operations of the motors M1, M2, M3 will be terminated.

If only the compare signal C is an abnormal signal (or the signal C has a high potential), then the signal Y1 outputted by the NOR gate circuit NOR1 will have a high potential, and the signal Y2 outputted by the NOR gate circuit NOR2 has a low potential. After the signals Y1, Y2 are computed by the NOR gate circuits NOR3, NOR4, the signal C1, C2 outputted by the NOR gate circuit NOR3 is a low potential signal, and the signal C3 outputted by the NOR gate circuit NOR4 is a high potential signal. If the motor control signals received by the motor driving circuits 11, 13 are enable signals having a low potential, then the motors M1, M2 can be operated normally, and the motor control signal received by the motor driving circuit 15 is a disable signal having a high potential, and the operation of the motor M3 will be terminated.

The design of the operative logic modules 22, 22A as shown in FIGS. 3 and 4 is given to illustrate the present invention only, but not intended to limit the scope of the present invention. For example, the operative logic module can be designed in such a way that if one of the motors fails, then the operations of all motors will be terminated, or if any motor fails, then the operation corresponding to the failed motor will be terminated. All of the above modifications are considered as equivalent operative logic modules and intended to be covered within the scope of the present invention. Furthermore, the AND gate circuit can be comprised of a NAND gate and a NOT gate, and the NOR gate circuit can be comprised of an OR gate and a NOT gate.

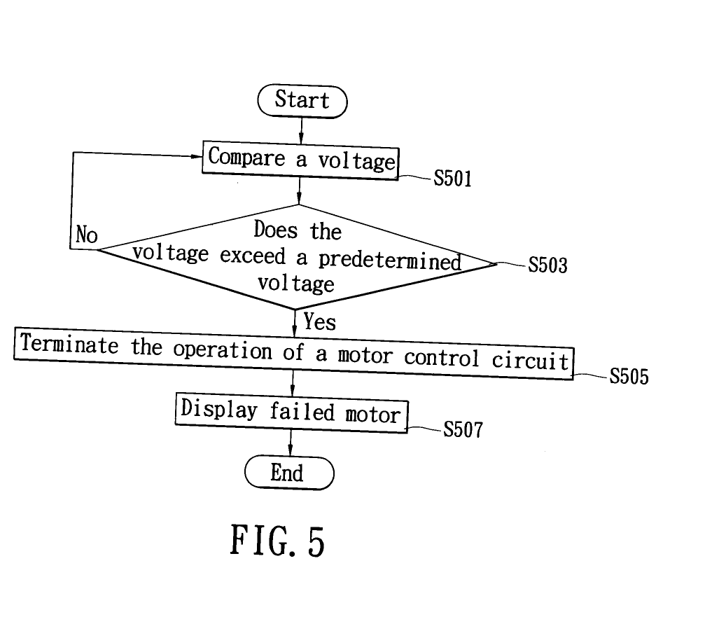

With reference to FIG. 5 for a flow chart of a method for protecting multi-motors in accordance with a preferred embodiment of the present invention, the method comprises the following steps:

S501: The comparison module 20 compares the working current of each motor M1, M2, M3 to determine whether or not an over current occurs, wherein the comparison is achieved by converting a working current of the motor M1, M2, M3 into a working voltage of the motor M1, M2, M3, and the working voltage of the motor M1, M2, M3 is compared against a predetermined voltage.

S503: Determine whether or not the working voltage of the motor M1, M2, M3 exceeds the predetermined voltage. If a determination result of Step (S503) is negative, then the working voltages of all motor M1, M2, M3 are smaller than the predetermined voltage, and the procedure returns to Step (S501).

S505: If the determination result of Step (S503) is affirmative, then the working voltage of at least one of the motors M1, M2, M3 is greater than the predetermined voltage, then the operations of all motor driving circuits 11, 13, and the operations of all motors M1, M2, M3 will be terminated.

S507: The status of the failed motor is displayed to notify a user.

If an over current occurs in any one of the motors in Step S505, then the operations of all motors will be terminated, but this step may terminate the operation of the failed motor only, and all other motors remain operating normally.

In summation of the description above, the present invention provides a protecting device for a machine or equipment that may have several motors operated at the same time, and the machine or equipment is not limited to the aforementioned office machine only. Furthermore the predetermined voltage used in the comparison module 20 of the present invention can be set based on the operating characteristics of different motors. If the present invention detects an over current in a motor, a processing mechanism with a first priority will be provided; wherein as an example for the processing mechanism, a portion or all of the operations of the motor driving circuits are terminated first, and then the control module notify users about the failure condition of the motor and shows the status of a failed motor. Therefore, the present invention can achieve the effects of protecting related circuits (including the motor driving circuit and the control module) and the motors, and notifying users about the information of the failed motor, so that the users can troubleshoot and eliminate the failure accordingly.

Although the present invention has been described with reference to the preferred embodiments thereof, it will be understood that the present invention is not limited to the details thereof. Various substitutions and modifications have been suggested in the foregoing description, and others will occur to those of ordinary skill in the art. Therefore, all such substitutions and modifications are intended to be embraced within the scope of the present invention as defined in the appended claims.

What is claimed is:

1. A protecting device for multi-motors, the motors being driven by a plurality of motor driving circuits, and the protecting device comprising:
a comparison module, for comparing a working voltage converted from a working current of each of the motors against a predetermined voltage, and outputting a compare signal according to a comparison result, such that if the working voltage is greater than the predetermined voltage, the outputted compare signal will be an abnormal signal, and if the working voltage is smaller than the predetermined voltage, the outputted compare signal will be a normal signal;
an operative logic module, for receiving the compare signal, and determining whether or not the abnormal signal shows up in the compare signal, and outputting at least one notice signal and at least one motor control signal outputted to the motor driving circuit according to the determination result; and
a control module, for receiving the notice signal, and outputting a warning signal according to the notice signal.

2. The protecting device for multi-motors of claim 1, wherein the comparison module comprises a plurality of compare circuits, and each compare circuit compares the working voltage against the predetermined voltage and outputs the compare signal.

3. The protecting device for multi-motors of claim 1, wherein the operative logic circuit is comprised of an AND gate circuit.

4. The protecting device for multi-motors of claim 3, wherein the AND gate circuit is comprised of a NAND gate and a NOT gate.

5. The protecting device for multi-motors of claim 1, wherein the operative logic circuit is comprised of a NOR gate circuit.

6. The protecting device for multi-motors of claim 5, wherein the NOR gate circuit is comprised of an OR gate and a NOT gate.

7. The protecting device for multi-motors of claim 1, wherein if the abnormal signal shows up in at least one of the compare signals, the operative logic module will output the notice signal to the control module and output the motor control signal to at least one of the motor driving circuits, and the motor control signal is a disable signal for terminating the operation of the motor driving circuit.

8. The protecting device for multi-motors of claim 1, further comprising a display module controlled by the control module for receiving the warning signal to display an error status of the motors.

9. The protecting device for multi-motors of claim 1, wherein the working voltage is a voltage produced by the working current at a resistor.

10. A method for protecting multi-motors, the motors being driven by a plurality of motor driving circuits, and the method comprising:
converting a working current of each of the motors into a working voltage and comparing the working voltage against a predetermined voltage, and outputting a compare signal according to a comparison result, such that if the working voltage is greater than the predetermined voltage, the outputted compare signal is an abnormal signal, and if the working voltage is smaller than the predetermined voltage, the outputted compare signal is a normal signal;
determining whether or not the abnormal signal shows up in the compare signals, and outputting at least one notice signal and at least one motor control signal outputted to the motor driving circuit according to the determination result; and
outputting a warning signal according to the notice signal.

11. The method for protecting multi-motors of claim 10, wherein the working voltage obtained by converting a working current of each of the motors is compared against a predetermined voltage by a plurality of compare circuits, and each of the compare circuits receives the working voltage and the predetermined voltage for a comparison, and outputs the compare signal.

12. The method for protecting multi-motors of claim 10, wherein the compare signals are for determining whether or not there is an abnormal signal by an AND gate circuit.

13. The method for protecting multi-motors of claim 12, wherein the AND gate circuit is comprised of a NAND gate and a NOT gate.

14. The method for protecting multi-motors of claim 10, wherein the compare signals are for determining whether or not there is an abnormal signal by a NOR gate circuit.

15. The method for protecting multi-motors of claim 14, wherein the NOR gate circuit is comprised of an OR gate and a NOT gate.

16. The method for protecting multi-motors of claim 10, wherein if the abnormal signal shows up in at least one of the compare signals, the notice signal will be outputted to a control module and the motor control signal will be outputted to one of the motor driving circuits, and the motor control signal is a disable signal for terminating the operation of the motor driving circuit.

17. The method for protecting multi-motors of claim 16, further comprising the step of outputting the warning signal to a display module to display an error status of the motor by the control module.

18. The method for protecting multi-motors of claim 10, wherein the working voltage is a voltage produced by the working current at a resistor.
